(19) United States
(12) Patent Application Publication
(10) Pub. No.: US 2008/0047589 A1
(43) Pub. Date: Feb. 28, 2008

(54) APPARATUS AND METHODS OF CLEANING SUBSTRATES

(75) Inventors: Tsung-Min Huang, Lujhou City (TW); Zin-Chang Wei, Hsin-Chu City (TW); Ming-Tsao Chiang, Jhubei City (TW)

Correspondence Address: DUANE MORRIS LLP;IP DEPARTMENT (TSMC), 30 SOUTH 17TH STREET, PHILADELPHIA, PA, 19103-4196, US

(73) Assignee: TAIWAN SEMICONDUCTOR MANUFACTURING CO., LTD., Hsin-Chu (TW)

(21) Appl. No.: 11/467,448

(22) Filed: Aug. 25, 2006

(51) Int. Cl. B08B 7/00; B08B 3/00

(52) U.S. Cl. 134/33; 134/149; 134/198; 134/151; 134/94.1; 134/34

(57) ABSTRACT

An apparatus for wafer cleaning includes an enclosure. A stage is within the enclosure. At least one first wall is within the enclosure, around the stage. A plate is within the enclosure and above the stage, operable to enclose a first region between the stage and the first wall. The apparatus further includes an exhauster fluidly coupled to the first region between the stage and the first wall.

### BACKGROUND OF THE INVENTION

1. Field of the Invention

The present invention relates to apparatus and methods of forming semiconductor structures, and more particularly to apparatus and methods of cleaning substrates.

2. Description of the Related Art

With advances associated with electronic products, semiconductor technology has been widely applied in manufacturing memories, central processing units (CPUs), liquid crystal displays (LCDs), light emission diodes (LEDs), laser diodes and other devices or chip sets. In order to achieve high-integration and high-speed goals, dimensions of semiconductor integrated circuits continue to shrink. Various materials and techniques have been proposed to achieve these integration and speed goals and to overcome manufacturing obstacles associated therewith. In addition, cycle time of a manufacturing process also becomes important, not only because it affects throughput of products, but also because it increases manufacturing costs.

Traditionally, wafers, after an etch or implantation process step, are subjected to a cleaning process which is generally referred to as a “Caro's process.” The cleaning process is performed in a wet bench apparatus which includes several tanks in which different chemicals (e.g., sulfuric acid/hydrogen peroxide mixture (SPM) solution, ammonia hydrogen peroxide mixture (APM) solution and deionized (DI) water) are provided. A wet bench apparatus is able to accommodate and process several lots of wafers in the same process. This wet-bench cleaning process, however, has a long cycle time. In order to shorten the cycle time of the wet-bench cleaning process, a single-wafer cleaning process has been used to replace the traditional wet-bench cleaning process.

FIG. 1A shows a cross-sectional view of a prior art single-wafer cleaning chamber. A chamber 100 includes chamber walls 110. A stage 120 is disposed within the chamber 100. The stage 120 comprises a stage plate 125 for supporting a wafer 150. Walls 130, generally refereed to as a chemical cup, are disposed within the chamber 100, surrounding the stage 120 to stop chemicals spun off from the wafer 150 and/or dispensed from a dispenser 140. The chemical dispenser 140, including a dispensing nozzle 145, is configured within the chamber 100 to dispense chemicals over the wafer 150. The dispensing nozzle 145 is a nanospray nozzle through which chemicals provided thereby are in the form of mist or vapor. Though the cleaning process is performed within the chamber 100, no other enclosure or shelter substantially isolates or seals the stage 120 from the region within the chamber 100 between walls 110 and walls 130, while the wafer 150 is subjected to a cleaning step. Usually, this cleaning process is referred to as a “semi-open” process.

Referring again to FIG. 1A, during a Caro's process step, SPM 160 is dispensed over the wafer 150 via the dispensing nozzle 145 for cleaning the wafer 150. As described above, the SPM 160 is in the form of mist or vapor that floats within the chamber 100. During and after the SPM process step, SPM residues 160a may attach to the walls 110, 130 and/or dispenser 140.

As shown in FIG. 1B, APM 170, also in form of mist and vapor, is dispensed over the wafer 150 via the dispensing nozzle 145 for cleaning the wafer 150. APM 170 also floats within the chamber 100, and APM residues 170a attach to the walls 110, 130 and/or dispenser 140. Some of the APM residues 170a may mix with the SPM residues 160a, forming residues NH₄SO₄ 180. Initially, the residues NH₄SO₄ 180 are in form of aqueous solution after the mixing. After several to tens of hours, hydrogen oxide (H₂O) of NH₄SO_{4(aq)} 180 may vaporize, and NH₄SO_{4(aq)} 180 is crystallized into solid as NH₄SO₄₍ₛ₎. The crystallized NH₄SO₄₍ₛ₎ 180 may detach from the walls 110, 130 and/or dispenser 140, falling on the wafer 150 while the wafer 150 is transferred and/or processed. Crystallized NH₄SO₄₍ₛ₎ 180 falling on the wafer 150 may result in shorts or opens in the integrated circuits formed on the wafer 150.

From the foregoing, improved wafer cleaning apparatus and methods of cleaning wafers are desired.

### SUMMARY OF THE INVENTION

In accordance with some exemplary embodiments, an apparatus for wafer cleaning includes an enclosure. A stage is within the enclosure. At least one first wall is within the enclosure, around the stage. A plate is configured within the enclosure and above the stage, operable to enclose a first region between the stage and the first wall. The apparatus further includes an exhauster fluidly coupled to the first region between the stage and the first wall.

In accordance with some exemplary embodiments, a method of single wafer cleaning comprises substantially enclosing a stage upon which a substrate is disposed by using at least one sealed container around the stage. A first chemical is dispensed over a surface of the substrate. A second chemical is dispensed over the surface of the substrate, wherein the first chemical chemically interacts with the second chemical.

The above and other features will be better understood from the following detailed description of the preferred embodiments of the invention that is provided in connection with the accompanying drawings.

### BRIEF DESCRIPTION OF THE DRAWINGS

Following are brief descriptions of exemplary drawings. They are mere exemplary embodiments and the scope of the present invention should not be limited thereto.

FIGS. 1A and 1B are cross-sectional views of a cleaning process using a prior art single-wafer cleaning apparatus.

FIGS. 2A and 2B are schematic top and cross-sectional views, respectively, of an exemplary apparatus for wet processing.

FIG. 3A-3G are schematic drawings of a clean room (CR) process by using the apparatus 200 described in connection with FIGS. 2A and 2B.

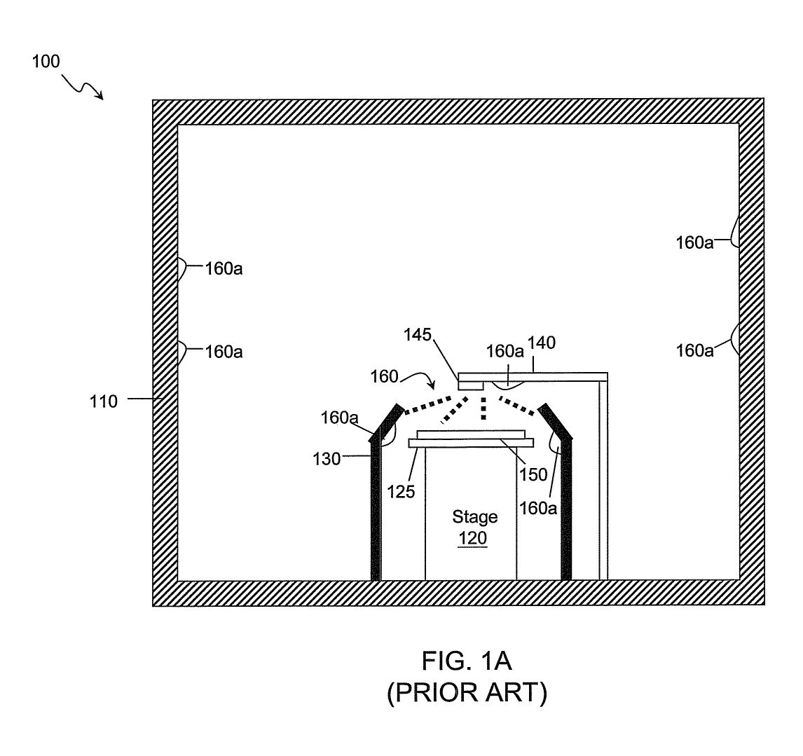

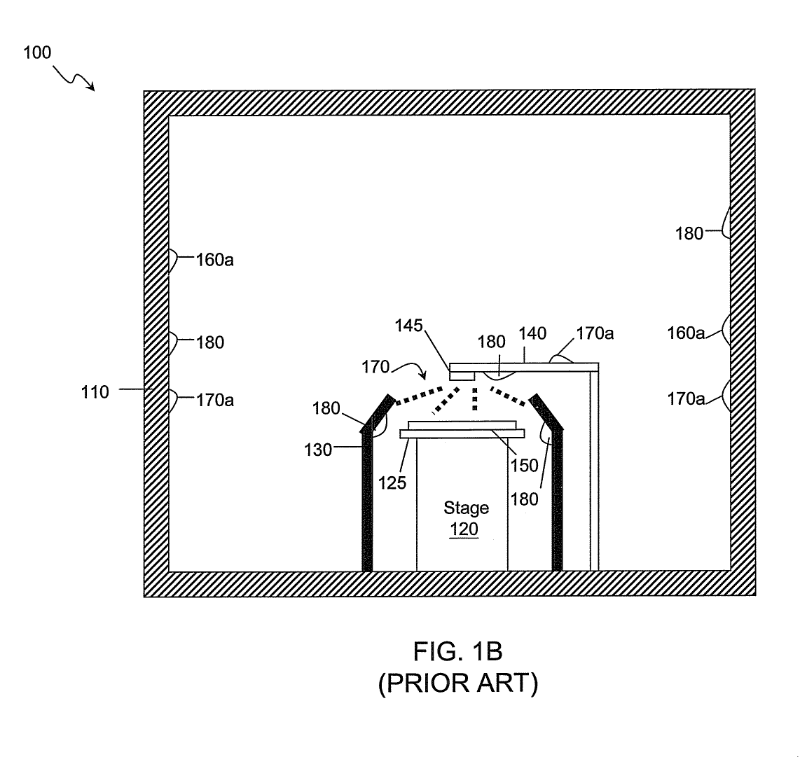

### DESCRIPTION OF THE PREFERRED EMBODIMENT

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

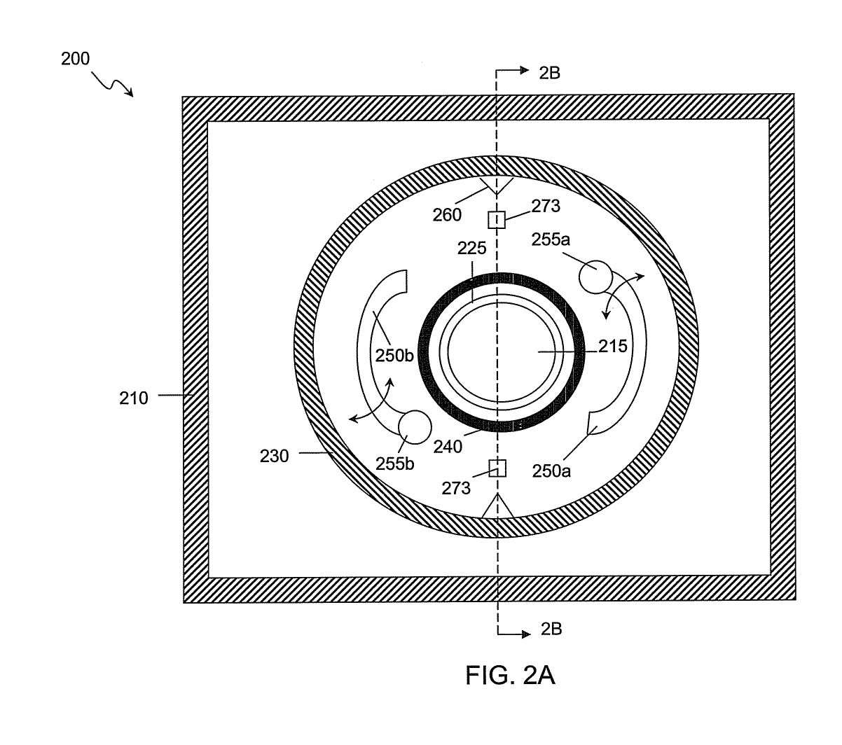

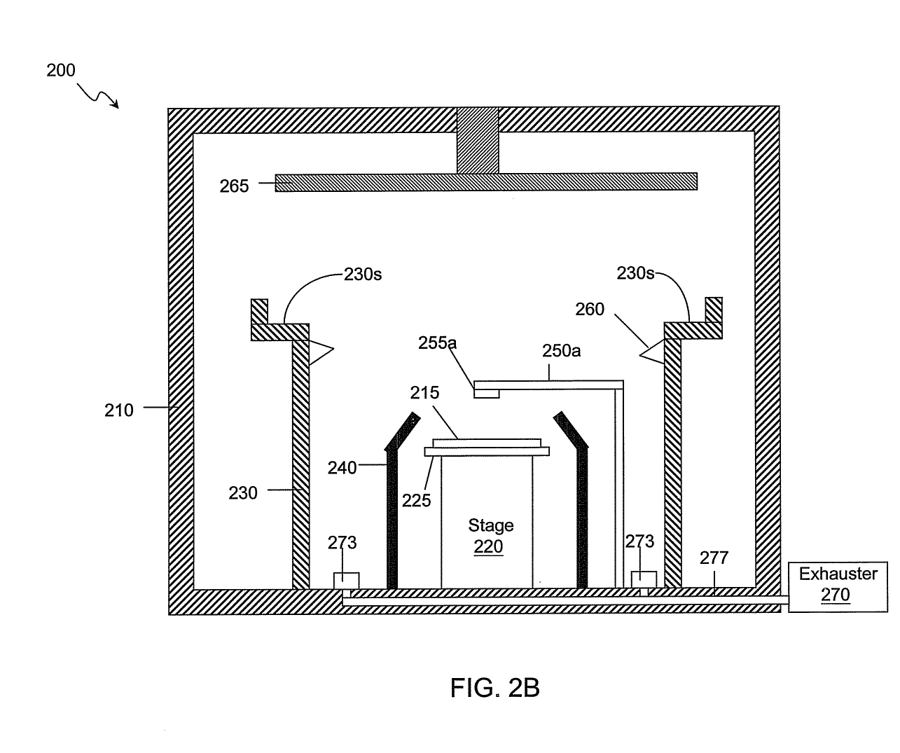

FIGS. 2A and 2B are schematic top and cross-sectional views, respectively, of an exemplary apparatus for wet processing. The top view shown in FIG. 2A omits the plate 265 shown in FIG. 2B to better show the apparatus. FIG. 2B is a cross-sectional view of the exemplary apparatus of FIG. 2A with the plate 265, taken along section line 2B-2B.

Referring to FIGS. 2A and 2B, an apparatus 200 for wet processing of a substrate may comprise an enclosure 210, stage 220 (not shown in FIG. 2A, but shown in FIG. 2B), stage plate 225 disposed over the stage 220, at least one wall 230 disposed within the enclosure 210, surrounding the stage 220 or stage plate 225, at least one wall 240 disposed between the stage 220 and the wall 230, a plate 265 to sealingly engage the top of the wall 230, at least one dispenser (e.g., dispensers 250a, 250b having nozzles 255a, 255b, respectively) configured within the enclosure 210 to dispense at least one chemical, and an exhauster 270 (shown in FIG. 2B) fluidly coupled to the a region between the stage 220 and the wall 230. The exhauster 270 may be fluidly coupled to such a region through, for example, at least one valve, e.g., valves 273. Although FIG. 2A shows two dispensers 250a, 250b, the system may include any desired number of dispensers, such as three, four or more than four, with a respective nozzle for each dispenser. For example, two dispensers may dispense first and second chemicals, and a third dispenser may dispense de-ionized water.

The apparatus 200 for wet processing of a substrate may be, for example, a single wafer wet process chamber. Compared with a wet bench, a single wafer wet process chamber can time efficiently process substrates or wafers. The enclosure 210 may comprise at least one opening (not shown) through which wafers or substrates can be transferred into, or out of, the enclosure 210. Though shown as a square, the shape of the enclosure 210 is not limited thereto. It can be any shape, as long as the enclosure 210 can accommodate desired components or parts of a wet process apparatus.

In FIGS. 2A and 2B, a substrate 215 is placed over the stage plate 225 such that the substrate 215 can be subjected to a wet process step. The substrate 215 can be a P-type or N-type silicon substrate, III-V compound substrate, display substrate such as a liquid crystal display (LCD), plasma display, electro luminescence (EL) lamp display, light emitting diode (LED) substrate, or the like (collectively referred to as, substrate 215), for example. Further, the substrate 215 may comprise at least one conductive layer such as polysilicon layer, metal-containing material (e.g., aluminum (Al), copper (Cu), AlCu, tungsten (W), titanium (Ti), titanium nitride (TiN), tantalum (Ta), tantalum nitride (TaN), combinations thereof, or the like), dielectric material (e.g., oxide, nitride, oxynitride, low-k dielectric material, ultra-low-k dielectric material, extreme-low-k dielectric material, combinations thereof, or the like), doped regions with dopants (e.g., boron (B), arsenic (As), phosphorous (P), or the like) formed within or over the substrate 215.

Turning to FIG. 2B, the stage 220 is disposed within the enclosure 210 and surrounded by the wall 230. The stage 220 is configured to support the substrate 215 such that the substrate 215 can be subjected to a wet process step. The stage 220 may be rotationally operable upward and/or downward with respect to the floor of the enclosure 210. The stage plate 225 disposed over the stage 220 may comprise, for example, an e-chuck, clamp or the like that is able to substantially fasten the substrate 215 thereover.

The wall 230 surrounding the stage 220 may be a cylinder having a top opening as shown in FIGS. 2A and 2B. In some embodiments, the shape of the wall 230 in the top view may be a circle, oval, square, rectangle, hexagon, octagon or the like, that may cooperate with the plate 265 to substantially seal the stage 220 therein. The wall 230 may comprise one or more shoulder portions 230s as shown in FIG. 2B to accommodate the plate 265 if the plate 265 is transferred downwardly. The wall 230 and plate 265 together form a container within the enclosure 210. The cooperation of the plate 265 and the wall 230 is described in detail below. The material of the wall 230 may comprise, for example, polypropylene (PP), polyethylene (PE), oxidized polyethylene (OPE), polyphenylene ether (PPE) or other material that does not substantially interact with chemicals used in wet process steps.

The apparatus 220 may further comprise at least one wall 240 disposed between the wall 230 and stage 220 to catch chemicals spun off from the surface of the substrate 215 and/or dispensed from the dispensers 250a, 250b. The wall 240 may surround the stage as shown in FIG. 2B and have a top opening so that chemicals can be provided into the region over the top surface of the substrate 215. In some embodiments, the wall 240 may comprise a top region inclined toward the stage 215 so as to desirably avoid rebound of chemicals from the wall 240. The wall 240 may be optional in some embodiments, if chemicals dispensed from the dispensers 250a, 250b can be desirably confined within the region sealed by the wall 230 and plate 265.

The apparatus 200 comprises at least one dispenser, e.g., dispensers 250a, 250b, configured within the enclosure 210 to dispense at least one chemical. The dispensers 250a, 250b may be disposed between the wall 230 and stage 220, or even between the wall 230 and wall 240 as shown in FIG. 2A. In some embodiments, multiple dispensers 250a, 250b are provided to introduce different chemicals, e.g., acid and base, which may chemically interact with each other over the surface of the substrate 215. By use of multiple dispensers 250a, 250b, undesired products or particles formed from reactions of chemicals can be avoided within the dispensers 250a, 250b and/or nozzles 255a, 255b.

Each of the dispensers 250a, 250b may comprise a nozzle 255a or 255b, such as a nanospray nozzle, through which chemicals (e.g., acid, base, sulfuric acid/hydrogen peroxide mixture (SPM) solution, ammonia hydrogen peroxide mixture (APM) solution, deionized (DI) water, combinations thereof, or the like) in form of solution, mist, vapor or the like are introduced over the surface of the substrate 215. The dispensers 250a, 250b may comprise respective conduits (not shown) configured therein, through which chemicals are provided. The dispensers 250a, 250b may be actuated along the direction of the arrows shown in FIG. 2A, transferring the nozzles 255a, 255b to a desired location, e.g. above the center of the stage plate 225, for dispensing chemicals.

The apparatus 200 may also comprise at least one nozzle 260 configured within an area sealed by the wall 230 and the plate 265 and operable to introduce at least one chemical therein. The chemical may comprise, for example, an acid, base, DI water, combinations thereof, or the like. In some embodiments, the nozzles 260 may comprise at least one nanosprayer nozzle. The nozzles 260 may be configured on the sidewalls of the wall 230 and/or on the surface of the plate 265, which faces the stage 220. Further, the nozzles 260 may be configured at the top region of the sidewalls of the wall 230 near to the shoulder portions 230s as shown in FIG. 2B, such that chemicals can be dispensed to the stage 220, wall 240, dispensers 250a, 250b and/or plate 265 when it is actuated while facing the stage 220. The nozzles 260 are provided to clean the components or parts of the apparatus 200 (e.g., the walls 230, 240, dispensers 250a, 250b, nozzles 255a, 255b, stage 220 and/or stage plate 255) after a wet process step is complete. Though two nozzles 260 are shown in FIG. 2B, the present invention is not limited thereto. A single nozzle or more than two nozzles may be provided and disposed on the wall 230 and/or the plate 265 as long as a desired cleaning situation can be achieved. In some embodiments, the nozzles 260 are optional if cleaning of the components or parts of the apparatus is not a concern.

The apparatus 200 comprises the plate 265 configured within the enclosure 210 and above the stage 220 as shown in FIG. 2B. The material of the plate 265 may comprise, for example, polypropylene (PP), polyethylene (PE), oxidized polyethylene (OPE), polyphenylene ether (PPE) or other material that does not substantially interact with chemicals used in wet process steps. The plate 265 is rotatable and/or operable facing toward the stage 220. The plate 265 may be coupled to an actuator (not shown) which transfers and/or rotate the plate 265. The actuator may transfer the plate 265 toward the stage 220 such that the plate 265 can be in cooperation with the wall 230 to substantially seal a region surrounding the stage 220. In some embodiments, in order to tightly seal this region, a sealing device, e.g., an O-ring or other gasket, (not shown) is disposed on the wall 230 and/or the plate 265 at a location where the wall 230 and the plate 265 are connected to each other. In other embodiments the shapes of mating portions of the plate 265 and the corresponding surface of wall 230 or the shoulder 230s are closely controlled in a cooperative relationship to provide a desired seal without any additional gasket. For example, the plate 265 and wall 230 may be circular, with a male thread around the plate's circumference, and a female thread on the wall 230.

The apparatus 200 comprises at least one exhauster 270 fluidly coupled to a region between the stage 220 and the wall 230. The exhauster 270 may further be fluidly coupled to a region between the walls 230 and 240 through valves 273 as shown in FIG. 2B. The exhauster 270 is actuated to exhaust mist, vapor or solution of chemicals that are introduced by the dispensers 250a, 250b during wet process steps. The exhauster 270 may be connected to the valves 273 via at least one conduit 277 such as a pipeline. In some embodiments, additional valves (not shown) may be configured between the stage 220 and the wall 240 and fluidly coupled to the exhauster 270 via the conduit 277. Though two valves are shown in FIGS. 2A and 2B, the present invention is not limited thereto. A single valve or more than two valves 273 can be configured to exhaust chemicals. Further, the location of the valves 273 is optional, and not limited to the floor of the enclosure 210. For example, the valves 273 may be disposed on the sidewalls of the walls 230, 240 and/or the stage 220 as long as chemicals can be desirably removed. In addition, more exhausters and conduits can be provided to achieve the purpose of desirably removing chemicals and/or particles.

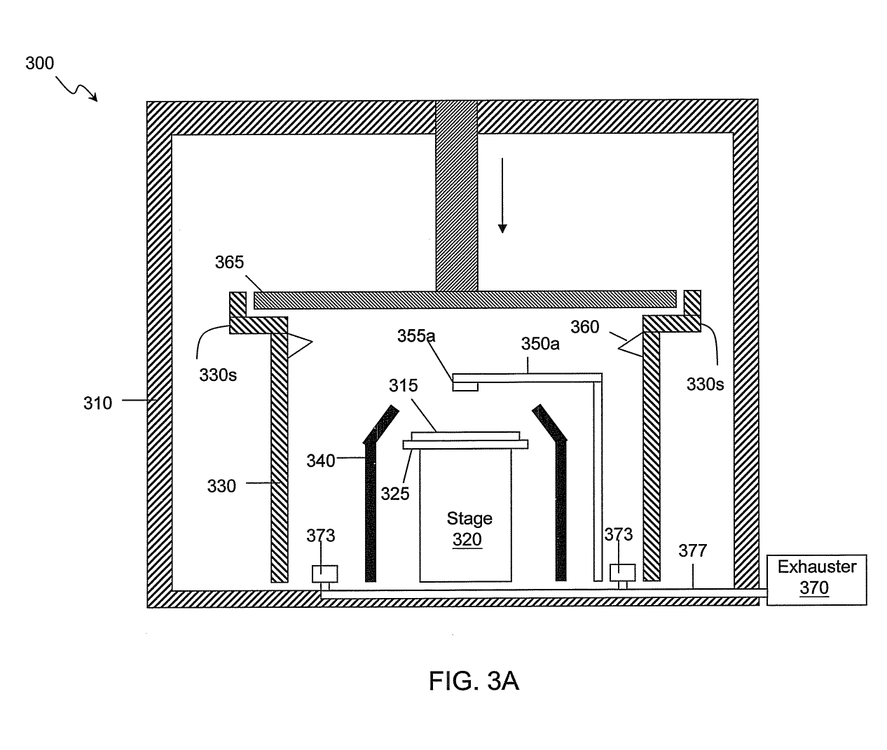

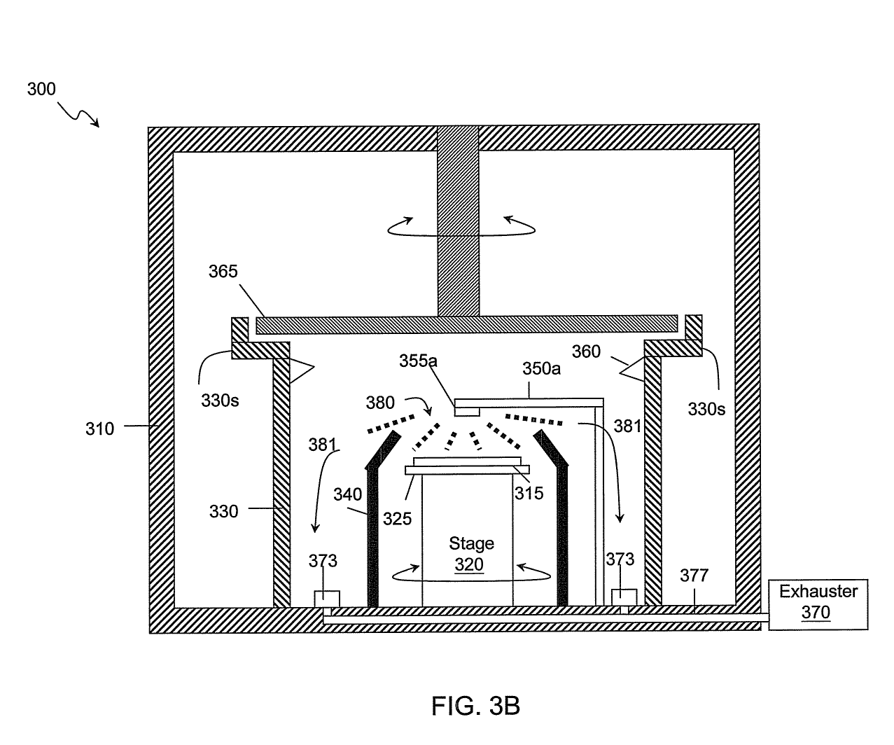

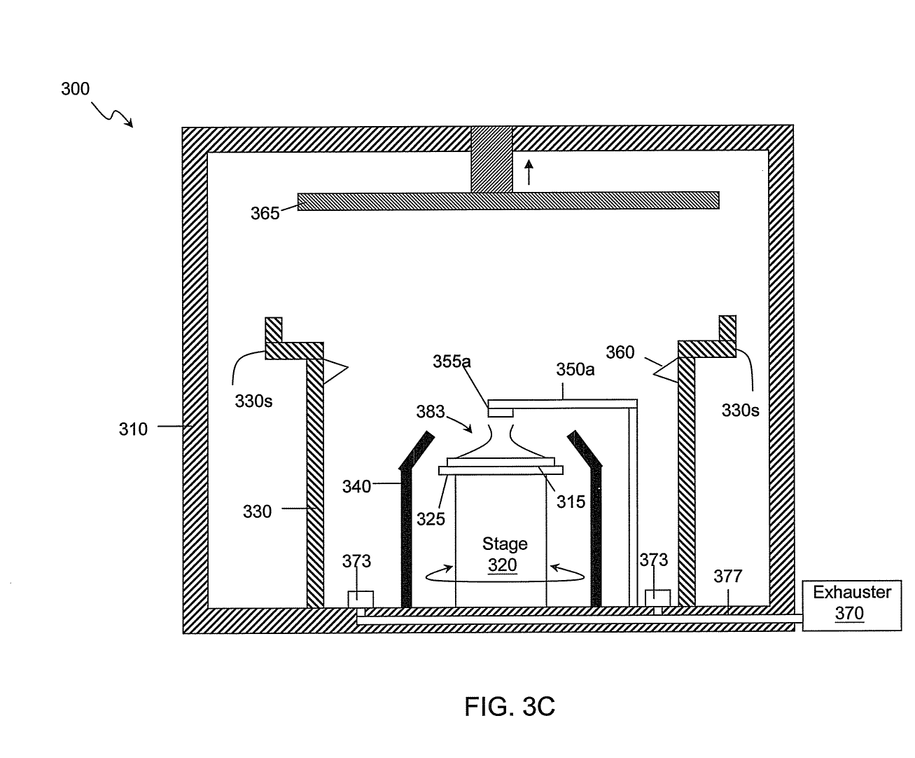

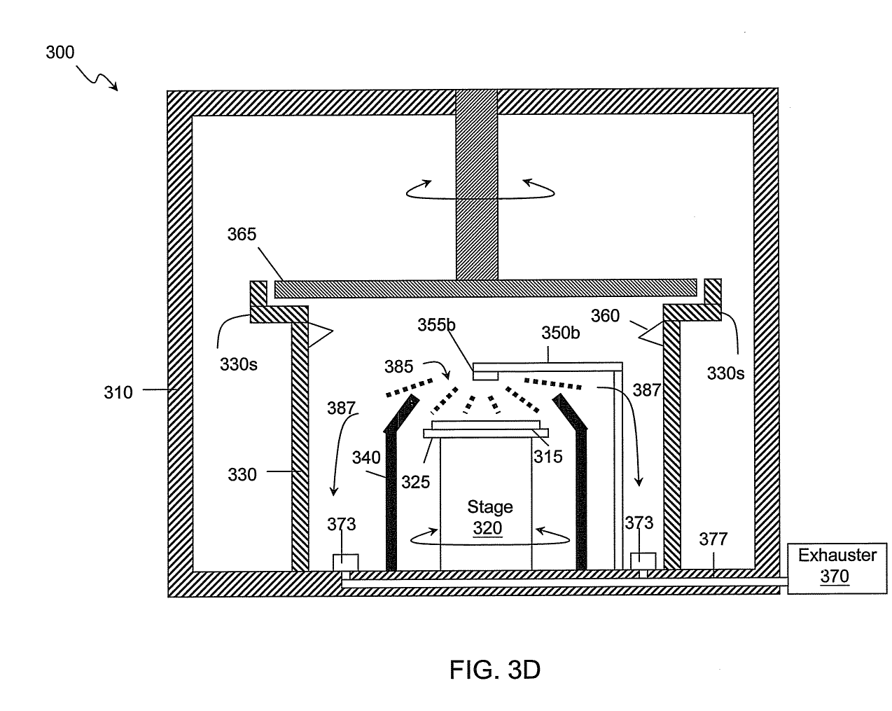

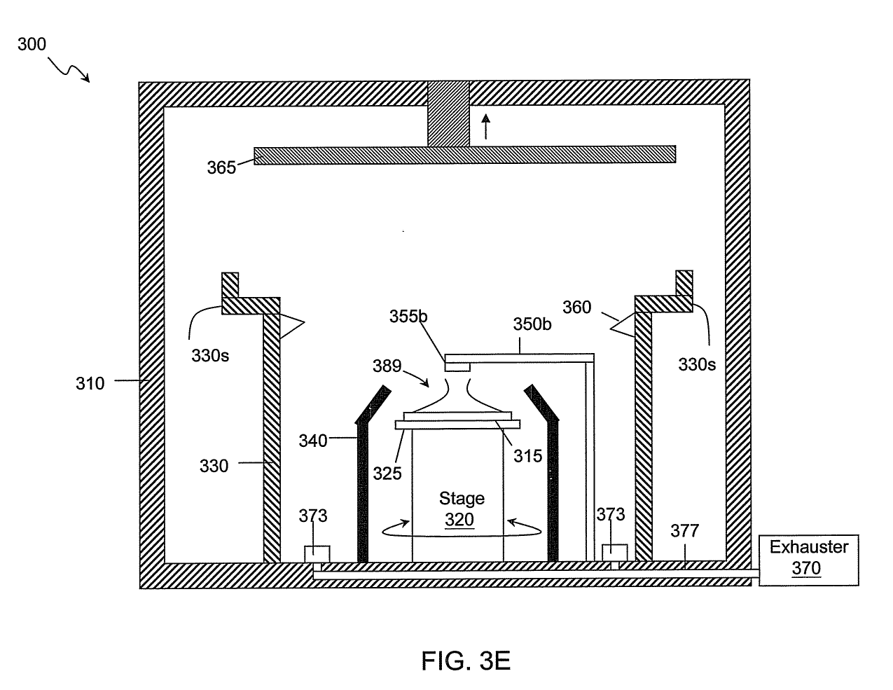

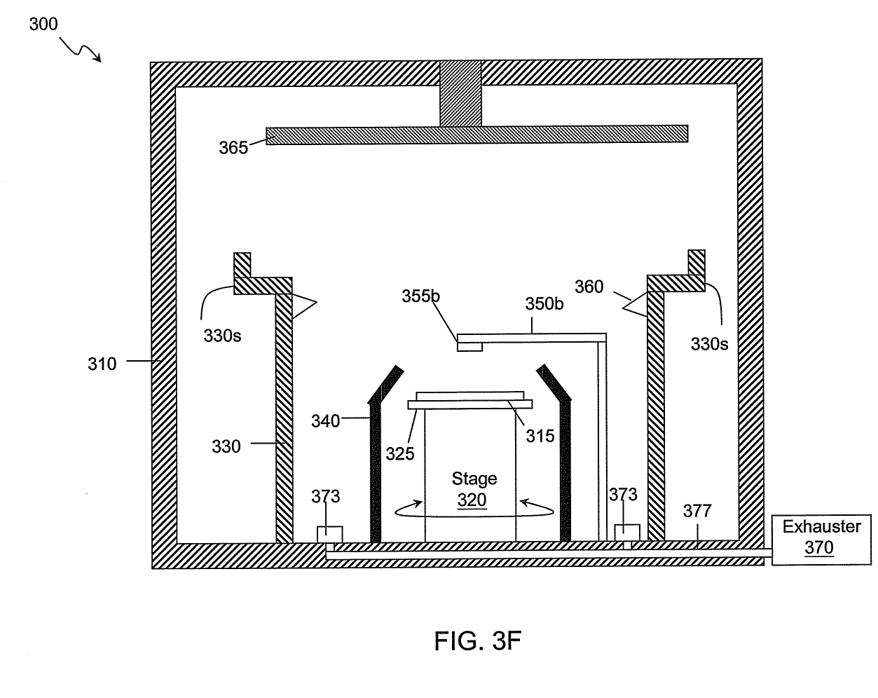

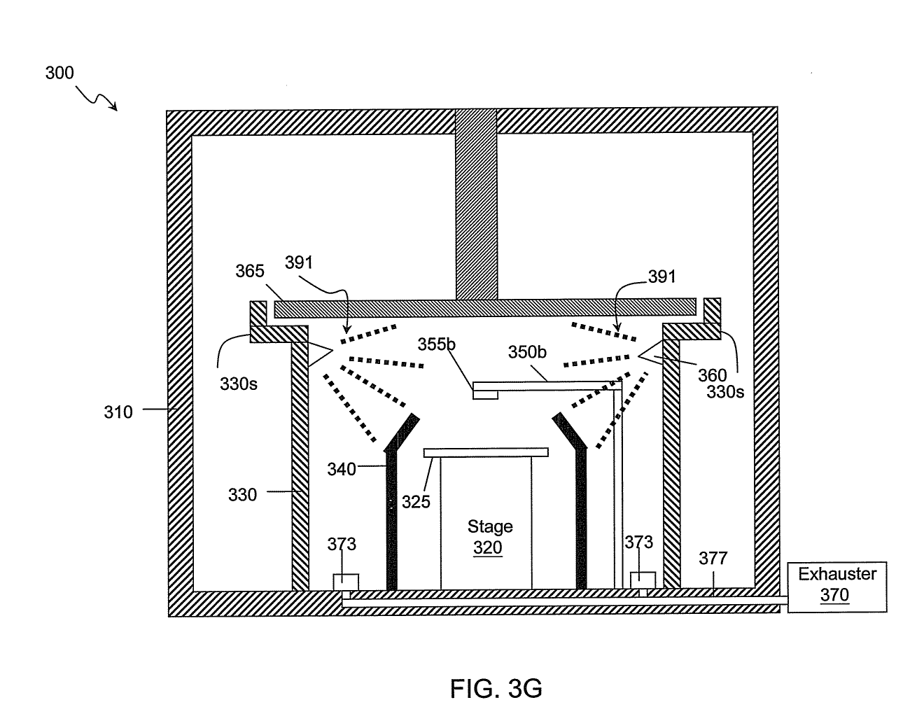

FIG. 3A-3G are schematic drawings of a clean room (CR) process using the apparatus 200 described in connection with FIGS. 2A and 2B. In FIGS. 3A-3G, like items are indicated by reference numerals having the same value as in FIGS. 2A and 2B, increased by 100.

Referring to FIG. 3A, a substrate 315 is placed over a stage plate 325 through an opening (not shown) of the enclosure 310. Before being placed over the stage plate 325, the substrate 315 may be subjected to a semiconductor process step, such as an etch process step, implantation process step, photolithographic process step, film deposition or formation process step, combinations thereof, or the like. The plate 365 is then actuated and transferred toward the stage 320 or the wall 330 as the direction indicated by the arrow shown in FIG. 3A. The plate 365 then stops over the shoulder portion 230s of the wall 330, cooperating with the wall 330 and substantially sealing the stage 320 in a region defined by the wall 330 and stage 365. In some embodiments, this region may be tightly sealed by a sealing device, such as an O-ring, (not shown) disposed between the wall 330 and the plate 365 at the shoulder region where they engage to each other.

In some embodiments, the plate 365 may also be actuated to rotate with respect to the axis thereof (e.g., if the plate 365 has threads around its circumference for forming a seal). It is noted that rotating the plate 365 at this step is optional.

Turning to FIG. 3B, the dispenser 350a dispenses mist, vapor and/or a solution of a chemical 380 through the nozzle 355a over the substrate 315. The chemical 380 may comprise, for example, an acid, base, sulfuric acid/hydrogen peroxide mixture (SPM) solution, ammonia hydrogen peroxide mixture (APM) solution, combinations thereof, or the like. In some embodiments using Caro's process, the chemical 380 comprises SPM solution (H₂SO₂+H₂O₂) with a temperature of about 130° C. Since the chemical 380 is in the form of a mist, vapor or solution, it may float and attach to the stage 320, stage plate 325, walls 330, 340, dispenser 350a and/or plate 365. As described above, the wall 330 and stage 365 substantially seal the processing region, so that no significant amount of the mist, vapor and/or solution of the chemical 380 escapes from this region.

While the dispenser 350a dispenses the chemical 380, the stage 320 and/or plate 365 are actuated and rotated at a rotational speed between about 300 revolutions per minute (rpm) and about 1,000 rpm. The stage 320 may be rotated along the direction of arrow shown in FIG. 3B to spin the chemical 380 across the top surface of the substrate 315 so that the chemical 380 can be substantially and uniformly dispensed thereover and/or particles (not shown) attached to the surface of the substrate 315 can be spun off. The plate 365 may be rotated along the direction of the arrow shown in FIG. 3B to deflect the chemical 380 dispensed from the dispenser 350a such that the region between the enclosure 310 and the wall 330 and plate 365 is not substantially subjected to contamination caused by the chemical 380.

In order to effectively remove the chemical 380 that is provided to clean the substrate 315, an exhauster 370 is actuated to remove mist, vapor and/or a solution of the chemical 380 indicated by arrows 381 as shown in FIG. 3B. The chemical 380 may be removed from the valves 373 through the conduit 377 to the exhauster 370. As described above, additional nozzles (not shown) may be configured within a region between the stage 320 and wall 340 to more effectively remove the chemical 380 dispensed therein. After dispensing of the chemical 380, rotation of the stage 320 and/or plate 365 may stop. In some embodiments, the exhauster 370 may also stop, after the dispensing step of the chemical 380.

Referring to FIG. 3C, the plate 365 is actuated and transferred upwardly in the direction indicated by the arrow. It is noted that the upward transfer of the plate 365 is optional if maintaining the position of the plate 365 as shown in FIG. 3B does not adversely affect subsequent processing of the substrate 315.

The same dispenser 350a or another dispenser (not shown) is actuated to dispense a chemical 383 over the substrate 315. A different dispenser is used to avoid formation of products resulting from reactions of the chemicals 380 and 383. The chemical 383 may comprise, for example, acid, base, DI water, combinations thereof, or the like. For embodiments using Caro's process, the chemical 383 comprises DI water. The chemical 383 is provided over the substrate 315 to carry away particles and/or residuals of the chemical 380 attached thereover.

While the dispenser 350a dispenses the chemical 383, the stage 320 may be actuated and rotated along the direction of arrow as shown in FIG. 3C. The rotation of the stage 320 is provided to effectively dispense the chemical 383 over the substrate 315 and/or carry away the particles and/or residuals of the chemical 380 attached over the substrate 315. The rotational speed of the stage 320 may be, for example, between about 300 rpm and about 1,000 rpm. In some embodiments, the exhauster 370 may also be actuated to more effectively remove particles, residuals of the chemical 380 and/or chemical 383, while the dispenser 350a dispenses the chemical 383.

As shown in FIG. 3D, the plate 365 may be actuated in the same way as or in a similar manner to that described above in connection with FIG. 3A. The dispenser 350b may dispense mist, vapor and/or solution of a chemical 385 through the nozzle 355b over the substrate 315. The chemical 385 may comprise, for example, an acid, base, sulfuric acid/hydrogen peroxide mixture (SPM) solution, ammonia hydrogen peroxide mixture (APM) solution, combinations thereof, or the like. The chemical 385 may chemically react with the chemicals 380 and/or 383 if they are mixed. For embodiments using Caro's process, the chemical 385 comprises APM solution (NH₄OH+H₂O₂). It is noted that sulfuric acid and ammonia chemically interact, creating NH₄SO₄ in form of solution as shown below:

H₂SO₂₍₁₎+NH₄OH_{(aq)}→NH₄SO_{4(aq)}

NH₄SO_{4(aq)}→NH₄SO_{4(s)+H}₂O

H₂O of NH₄SO_{4(aq)} which is formed from this chemical reaction in an atmospheric environment vaporizes, such that solid NH₄SO₄₍ₛ₎ is crystallized at the locations where NH₄SO_{4(aq)} is attached. NH₄SO₄₍ₛ₎, however, can be substantially avoided as described below.

While the dispenser 350b dispenses the chemical 385, the stage 320 and/or plate 365 may be actuated and/or rotated at a rotational speed between about 300 revolutions per minute (rpm) and about 1,000 rpm. The stage 320 may be rotated along the direction of arrow shown in FIG. 3D to spin the chemical 385 across the top surface of the substrate 315 so that the chemical 385 can be substantially and uniformly dispensed thereover and/or particles (not shown) attached on the surface of the substrate 315 can be spun off. The plate 365 may be rotated along the direction of the arrow shown in FIG. 3D to deflect the chemical 385 dispensed from the dispenser 350b, such that the region between the enclosure 310 and the wall 330 and plate 365 will not be substantially subjected to contamination caused by the chemical 385.

As described above in connection with FIG. 3B, use of the exhauster 370 may effectively reduce the amount of residues of the chemical 380 within the region defined by the wall 330 and plate 365. With the reduced level of the chemical 380, the amount of NH₄SO_{4(aq)} created from the chemicals 380 and 385 attached to these components of the apparatus 300 (e.g., the stage 320, stage plate 325, walls 330, 340, dispensers 350a, 350b, and/or nozzles 355a, 355b) is substantially reduced. Further, since the wet process is performed within the region substantially sealed by the wall 330 and plate 365, formation of NH₄SO_{4(aq)} at the region between the enclosure 310 and the region sealed by the wall 330 and plate 365 is substantially eliminated. The reduction or elimination of the amount of NH₄SO_{4(aq)} attached to these components of the apparatus 300 can be further achieved by the step described below.

In order to effectively remove NH₄SO_{4(aq)} and the chemical 385 that is dispensed out of the substrate 315, the exhauster 370 is actuated to remove NH₄SO_{4(aq)} and/or mist, vapor and/or solution of the chemical 385 indicated by arrows 387 shown in FIG. 3D. The chemical 385 and NH₄SO_{4(aq) a} may be removed from the valve 373 through the conduit 377 to the exhauster 370. Since the amount of the chemical 385 dispensed from the substrate 315 is also effectively reduced, the amount of NH₄SO_{4(aq)} formed from the reaction of chemicals 380 and 385 is further reduced. After dispensing the chemical 385, rotation of the stage 320 and/or plate 365 may stop. In some embodiments, the exhauster 370 may also stop, after the dispensing step of the chemical 385.

Referring to FIG. 3E, the plate 365 is actuated and transferred away from the stage 320 in the direction indicated by the arrow. It is noted that the upward transfer of the plate 365 is optional, if maintaining the position of the plate 365 as shown in FIG. 3D does not adversely affect subsequent processing of the substrate 315.

The same dispenser 350b or another dispenser (not shown) is actuated to dispense a chemical 389 over the substrate 315. A different dispenser is used to avoid products resulting from reactions of the chemicals 385 and 389. The chemical 389 may comprise, for example, acid, base, DI water, combinations thereof, or the like. For embodiments using Caro's process, the chemical 389 comprises DI water. The chemical 389 is provided over the substrate 315 to carry away NH₄SO_{4(aq)} and/or residuals of the chemical 385 attached thereover.

While the dispenser 350b dispenses the chemical 389, the stage 320 may be actuated and rotated along the direction of the arrow as shown in FIG. 3E. The rotation of the stage 320 is provided to effectively dispense the chemical 389 over the substrate 315 and/or carry away NH₄SO_{4(aq)} and/or residues of the chemical 385 attached over the substrate 315. The rotational speed of the stage 320 may be, for example, between about 300 rpm and about 1,000 rpm. In some embodiments, the exhauster 370 may also be actuated to more effectively remove NH₄SO_{4(aq)}, residues of the chemical 385 and/or chemical 389, while the dispenser 350b dispenses the chemical 389.

FIG. 3F shows that the stage 320 spin-dries the substrate 315. In this process step, the stage 320 may be actuated and rotated at a rotational speed between about 300 rpm and about 1,000 rpm to spin off the remaining chemical 389 over the substrate 315 in the direction indicated by the arrow shown in FIG. 3F. During this spin-dray process step, the plate 365 may also be actuated toward, or maintained at, the position in cooperation with the wall 330 to substantially seal the stage 320. In some embodiments, the plate 365 may also be rotated at a speed between of about 300 rpm and about 1,000 rpm. In some embodiments, the exhauster 370 may also be actuated to remove the chemical 389 while the stage 320 rotates. The spin-dry step may be optional if the chemical 389 can be desirably spun off by the step described in connection with FIG. 3E.

After the spin-dry process, the plate 365 is actuated and transferred upward. Rotations of the plate 365 and stage 320 also stop. Also, the exhauster 370 may be turned off. The substrate 315 is then transferred from the enclosure 310 through an opening (not shown) thereof by, for example, a robotic system (not shown) to a cassette, processing apparatus or the like for subsequent processing.

Referring to FIG. 3G, after the removal of the substrate 315, the plate 365 is again actuated and transferred toward the stage 320. The nozzles 360 are then actuated to dispense mist, vapor and/or a solution of a chemical 391 to removes residues of the chemicals 380, 383, 385, 389 and/or NH₄SO₄ attached on the components, e.g., the stage 320, stage plate 325, walls 330, 340, dispensers 350a, 350b, nozzles 355a, 355b and/or plate 365, confined within the region defined by the wall 330 and plate 365. The chemical 391 may comprise acid, base, DI water, combinations thereof, or the like, for example.

The nozzles 360 may also be actuated to dry these components of the apparatus 300 after the dispensing of the chemical 391. This process may use nitrogen, an inert gas (e.g., helium (He) or argon (Ar)), or the like to dry these components (e.g., the stage 320, stage plate 325, walls 330, 340, dispensers 350a, 350b, nozzles 355a, 355b and/or plate 365). After the purging process step, the apparatus 300 is ready for processing the next substrate.

Although the examples of FIGS. 2A-2B and 3A-3G include a container formed by a side wall 230, 330 and a mating plate 265, 365, other types of containers having sides and a top may be used to enclose the processing region. For example, the container may be a one-piece container having an open bottom that engages the floor of enclosure 210, 310 to form a closed, sealed container. The one-piece container may be, for example, a cylinder with a closed top and open bottom, a cuboid with an open bottom, or a “bell-jar” shaped enclosure. Using a one-piece container, the entire container is actuated to a position for mating with the floor of the enclosure 210, 310, at the same points in the process in which the plates 265, 365 are actuated. One of ordinary skill in the art can readily construct other container shapes and configurations that can be substituted for the combination of the side wall 230, 330 and the plate 265, 365.

Although the present invention has been described in terms of exemplary embodiments, it is not limited thereto. Rather, the appended claims should be construed broadly to include other variants and embodiments of the invention which may be made by those skilled in the field of this art without departing from the scope and range of equivalents of the invention.

What is claimed is:

1. An apparatus for wafer cleaning, comprising:
an enclosure;
a stage within the enclosure;
at least one first wall disposed within the enclosure, around the stage;
a plate within the enclosure and above the stage, operable to enclose a first region between the stage and the first wall; and
an exhauster fluidly coupled to the first region between the stage and the first wall.

2. The apparatus of claim 1, wherein the stage is rotatable.

3. The apparatus of claim 1, wherein the plate is rotatable and operable to substantially seal the stage within the first wall.

4. The apparatus of claim 1 further comprising at least one second wall disposed between the first wall and the stage.

5. The apparatus of claim 4, wherein the exhauster is fluidly coupled to a second region between the first and second walls.

6. The apparatus of claim 1 further comprising at least one dispenser configured within the enclosure to dispense at least one chemical.

7. The apparatus of claim 6, wherein the dispenser comprises a nanospray nozzle.

8. The apparatus of claim 1 further comprising at least one nozzle within an area sealed by the first wall and the plate to introduce at least one chemical therein.

9. An apparatus for wafer cleaning, comprising:
an enclosure;
a rotatable stage within the enclosure;
at least one first wall within the enclosure, around the stage;
at least one second wall between the first wall and the stage;
a plate within the enclosure and above the stage, rotatable and movable to substantially seal the stage within the first wall; and
an exhauster fluidly coupled to a first region between the first wall and second wall.

10. The apparatus of claim 9 further comprising at least one dispenser within the enclosure to dispense at least one chemical.

11. The apparatus of claim 10, wherein the dispenser comprises a nanospray nozzle.

12. The apparatus of claim 9 further comprising at least one nozzle within an area sealed by the first wall and the plate to introduce at least one chemical therein.

13. A method of wafer cleaning, comprising the steps of:
substantially enclosing a stage upon which a substrate is disposed within at least one sealed container, the container being located within a processing chamber;
dispensing a first chemical over a surface of the substrate through a first nozzle; and
dispensing a second chemical over the surface of the substrate through a second nozzle, so that formation of interaction products in the first and second nozzles is avoided, if the first and second chemicals are capable of interacting with each other.

14. The method of claim 13, wherein the first chemical comprises a sulfuric acid/hydrogen peroxide mixture (SPM) solution.

15. The method of claim 13, wherein the second chemical comprises an ammonia hydrogen peroxide mixture (APM) solution.

16. The method of claim 13, wherein the step of dispensing the second chemical comprises using a nanospray nozzle.

17. The method of claim 13 further comprising rotating the stage while dispensing at least one of the first chemical and second chemical.

18. The method of claim 13 further comprising rotating a plate while dispensing at least one of the first chemical and the second chemical, at a sufficiently high rotational speed to deflect the first and second chemicals from the plate.

19. The method of claim 13 further comprising dispensing deionized (DI) water and purging nitrogen (N₂) to at least one of the plate, stage and wall.

20. The method of claim 13 further comprising dispensing deionized (DI) water to the substrate.

21. The method of claim 13 further comprising exhausting the first chemical and second chemical, while the steps of dispensing the first chemical and second chemical are performed.

22. The method of claim 13, further comprising:
sealing the container by actuating a plate to engage an opening of the container;
rotating the plate while dispensing at least one of the first chemical and the second chemical, at a sufficiently high rotational speed to deflect the first and second chemicals from the plate; and
exhausting the first chemical and second chemical, while the steps of dispensing the first chemical and second chemical are performed.

23. The method of claim 22, further comprising rotating the stage at a sufficiently high rotational speed to distribute at least one of the first chemical and the second chemical across the surface of the substrate.

24. The method of claim 22, further comprising rotating the stage at a sufficiently high rotational speed to spin dry the substrate.
